(19) United States
(12) Patent Application Publication
(10) Pub. No.: US 2006/0089164 A1
(43) Pub. Date: Apr. 27, 2006

(54) Method and system for transmitting MMS notification message

(75) Inventor: Chang-Ho Lee, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/227,739

(22) Filed: Sep. 15, 2005

(30) Foreign Application Priority Data
Oct. 22, 2004 (KR) 10-2004-0084933

(51) Int. Cl. H04Q 7/20

(52) U.S. Cl. 455/466

(57) ABSTRACT

Disclosed is a method for transmitting an MMS notification message including the steps of transmitting the MMS notification message including information used for receiving an MMS message to a receiving subscriber terminal, and retransmitting the MMS notification message to another subscriber terminal designated in advance by a subscriber of the subscriber terminal when transmission check information of the MMS notification message is not provided from the subscriber terminal or the MMS message is not requested by the subscriber terminal within a predetermined period of time.

### PRIORITY

This application claims priority under 35 U.S.C. § 119 to an application entitled “Method And System For Transmitting MMS Notification Message” filed in the Korean Intellectual Property Office on Oct. 22, 2004 and assigned Serial No. 2004-84933, the contents of which are incorporated herein by reference.

### BACKGROUND OF THE INVENTION

1. Field of the Invention

The present invention relates to a Multimedia Messaging Service (MMS), and more particularly to a method and a system for transmitting an MMS notification message used for notifying an MMS message.

2. Description of the Related Art

The bandwidth of mobile communication networks has greatly increased with the recent development of new technologies. Therefore, it is now possible to provide an MMS for transmitting/receiving an MMS message, which includes a large quantity of text, image, video, voice and other data using the increased bandwidth.

In detail, a service provider providing the MMS transmits an MMS notification message to a receiving subscriber terminal through an SMS (Short Message Service) bearer. Herein, a Wireless Datagram Protocol (WDP) included in the header portion of the MMS notification message contains a port number or URL information used when downloading the MMS message.

The subscriber terminal receiving the MMS notification message connects to the corresponding service provider by means of the URL information included in the MMS notification message, and receives an MMS message transmitted from the service provider. The MMS notification message contains information enabling connection to the service provider providing the MMS. Accordingly, the subscriber terminal cannot receive the MMS message without receiving the MMS notification message.

Further, there may be a case in which the subscriber terminal does not receive the MMS notification message or a subscriber cannot check the MMS notification message received in the subscriber terminal. For example, when the subscriber terminal is powered off, the subscriber terminal cannot receive the MMS notification message. Further, when the subscriber loses or fails to carry the subscriber terminal, the subscriber cannot check an MMS notification message received in the subscriber terminal.

As described above, when the subscriber terminal does not receive the MMS notification message or the subscriber cannot check the MMS notification message received in the subscriber terminal, the subscriber cannot receive the MMS notification message. In addition, the subscriber cannot receive an MMS message in relation to the MMS notification message.

Further, even though a transmitter notifies a receiving subscriber of an MMS message through another communication medium due to an urgent transmission of the MMS message, the receiving subscriber cannot receive the MMS message when a subscriber terminal does not receive an MMS notification message at least because of the aforementioned reasons.

Accordingly, in the prior art, in consideration of a case where it is impossible to receive or check an MMS notification message, it is highly desirable to develop technology capable of retransmitting the MMS notification message to another subscriber terminal designated by a subscriber, and enabling the subscriber terminal of the subscriber to receive an MMS message regardless the subscriber terminal's situation.

### SUMMARY OF THE INVENTION

Accordingly, the present invention has been made to solve the above-mentioned problems occurring in the prior art, and it is an object of the present invention to provide a method and a system for retransmitting an MMS notification message to another subscriber terminal according to a subscriber's request.

It is another object of the present invention to provide a method and a system for transmitting an MMS notification message, which can retransmit the MMS notification message to other subscriber's terminals when the MMS notification message is not normally received in a subscriber's terminal.

It is further another object of the present invention to provide a method and a system for transmitting an MMS notification message, which can retransmit the MMS notification message, which has been retransmitted to other subscriber's terminals, to a receiving subscriber terminal when the receiving subscriber terminal having failed to normally receive the MMS notification message returns to a normal state of receiving the MMS notification message.

In accordance with one aspect of the present invention, there is provided a method for transmitting an MMS notification message, the method including the steps of: transmitting the MMS notification message including information used for receiving an MMS message to a receiving subscriber terminal; and retransmitting the MMS notification message to another subscriber terminal designated in advance by a subscriber of the subscriber terminal when transmission check information of the MMS notification message is not provided from the subscriber terminal or the MMS message is not requested by the subscriber terminal within a predetermined period of time.

In accordance with another aspect of the present invention, there is provided an MMS system including subscriber terminals for requesting and receiving an MMS message through a wireless network by means of information used for receiving the MMS message included in an MMS notification message; an SMS center for receiving the MMS notification message and providing the MMS notification message to a corresponding subscriber terminal; and a service server for generating the MMS notification message for the MMS message and transmitting the MMS notification message to the corresponding subscriber terminal through the SMS center when the MMS message is requested by the corresponding subscriber terminal of the subscriber terminals, and retransmitting the MMS notification message to another subscriber terminal designated in advance when the corresponding subscriber terminal does not provide transmission check information of the MMS notification message or does not request the MMS message within a predetermined period of time.

According to an embodiment of the present invention, when there is a subscriber's request or a subscriber terminal fails to normally receive an MMS notification message, the MMS notification message is transmitted to another subscriber terminal designated in advance, so that the subscriber can receive the MMS notification message by means of said another subscriber terminal.

In the present invention, when a subscriber terminal having failed to normally receive an MMS notification message returns to a normal state of receiving the MMS notification message, an MMS notification message transmitted to another subscriber terminal is retransmitted to the subscriber terminal, so that a subscriber can receive an MMS message even through its own subscriber terminal.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram schematically showing the construction of an MMS system according to the present invention;

FIG. 2 is a flow diagram illustrating a transmission procedure of an MMS notification message according to a first preferred embodiment of the present invention;

FIGS. 3 to 5 are flow charts illustrating a transmission method of an MMS notification message according to a first preferred embodiment of the present invention;

FIG. 6 is a flow diagram illustrating a transmission procedure of an MMS notification message according to a second preferred embodiment of the present invention; and

FIGS. 7 and 8 are flow charts illustrating a transmission method of an MMS notification message according to a second preferred embodiment of the present invention.

### DETAILED DESCRIPTION OF THE PREFERRED EMBODIMENT

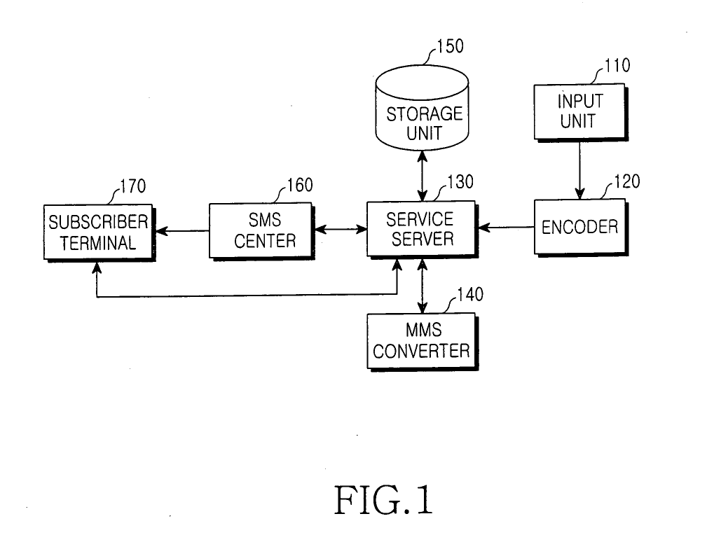

Hereinafter, the construction of an MMS system according to a preferred embodiment of the present invention will be described with reference to FIG. 1.

An input unit 110 inputs various types of multimedia data and provides the multimedia data to an encoder 120. The encoder 120 encodes the multimedia data received from the input unit 110, constructs an MMS message, and provides the MMS message to a service server 130. An MMS converter 140 converts the MMS message according to the environments of a subscriber terminal 170. A storage unit 150 provides a storage area for transmission/reception of the MMS message by the service server 130.

The service server 130 receives the MMS message generated through the aforementioned processes or an MMS request message from the subscriber terminal 170, and provides the MMS messages to the subscriber terminal 170.

More specifically, when the transmission of the MMS message is requested, the service server 130 provides the corresponding subscriber terminal 170 with an MMS notification message including information used for receiving the MMS message through an SMS center 160. Herein, the MMS notification message is an SMS message.

When the subscriber terminal 170 requests the service server 130 to transmit the MMS message according to the MMS notification message through a wireless network, the service server 130 provides the subscriber terminal 170 with the corresponding MMS message through the wireless network.

Further, after the service server 130 transmits the MMS notification message, when the reception of the MMS notification message is not reported or when a corresponding subscriber does not request the transmission of an MMS message even after passage of a predetermined time period, the service server 130 determines that a corresponding subscriber terminal has failed to normally receive the MMS notification message and retransmits the MMS notification message to another subscriber terminal designated in advance.

Furthermore, when the subscriber terminal, which has been determined as the subscriber terminal having failed to normally receive the MMS notification message due to various reasons, requests the transmission of the MMS message or an MMS notification item, the service server 130 retransmits the MMS notification message used for notifying the MMS message, which has not been provided to the corresponding subscriber terminal, and the MMS notification message, which has been retransmitted to another subscriber terminal, to the corresponding subscriber terminal.

In addition, the service server 130 stores information representing whether each MMS message has been transmitted to a subscriber terminal or another subscriber terminal, and stores list information for the MMS notification message which has been retransmitted to another subscriber terminal.

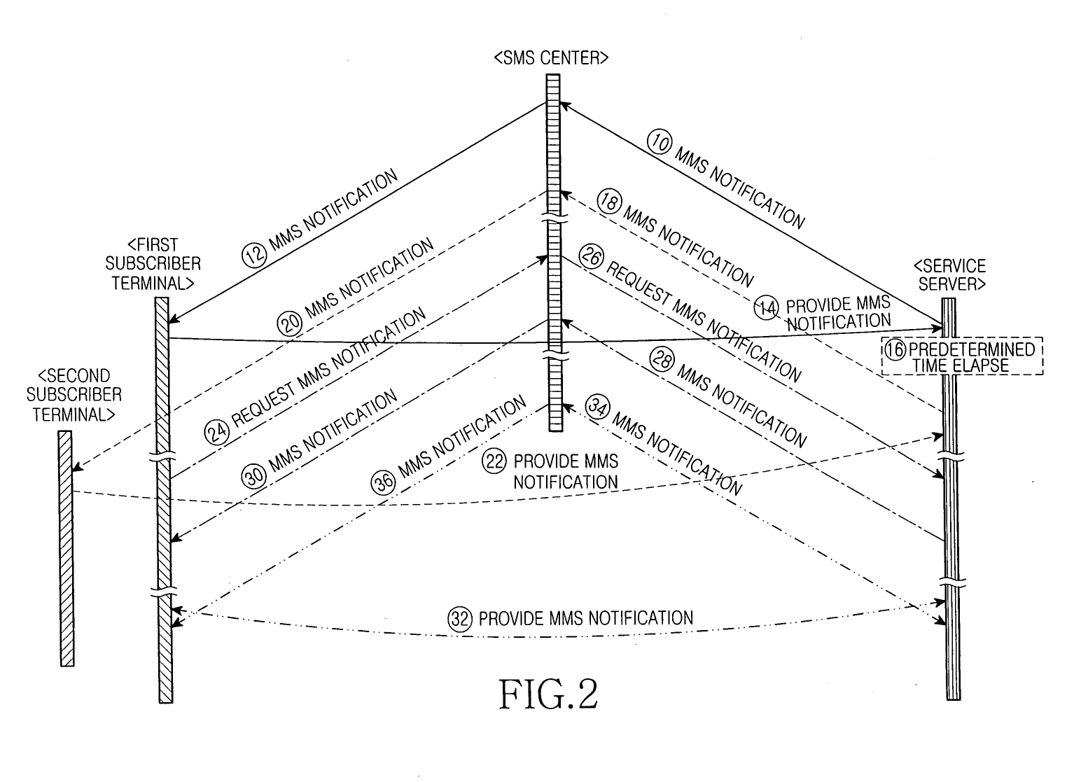

Hereinafter, a processing procedure of the above system will be described with reference to FIG. 2.

When the transmission of an MMS message is requested, the service server 130 orders the SMS center 160 to transmit an MMS notification message, which includes URL information used when receiving the MMS message, etc., to a corresponding receiving subscriber terminal (a first subscriber terminal) at step 10.

The SMS center 160 transmits the MMS notification message to the first subscriber terminal according to the order of the service server 130 at step 12.

The first subscriber terminal notifies a subscriber of the received MMS notification message. The subscriber may request the service server 130 to transmit the MMS message in relation to the MMS notification message according to the notification. When the request occurs, the service server 130 provides the first subscriber terminal with the MMS message at step 14.

If the first subscriber terminal fails to normally receive the MMS notification message or the user of the first subscriber terminal does not check the MMS notification message, the user cannot request the service server 130 to transmit the MMS message.

Accordingly, after the transmission of the MMS notification message, when the SMS center 160 transmits check information for the MMS notification message to the service server 130 or the first subscriber terminal does not request the service server 130 to transmit the MMS message in relation to the MMS notification message even after passage of a predetermined time at step 16, the service server 130 retransmits the MMS notification message to another subscriber terminal (e.g., a second subscriber terminal) designated in advance by the subscriber of the first subscriber terminal at step 18 and step 20.

When the second subscriber terminal receiving the MMS notification message requests the service server 130 to transmit the MMS message, the service server 130 provides the corresponding MMS message to the second subscriber terminal at step 22.

Further, when the first subscriber terminal normally operates or it is possible to check a message through the first subscriber terminal, the subscriber of the first subscriber terminal may request the service server 130 to retransmit the MMS notification message in order to receive the MMS message, which has not been received in the first subscriber terminal, or the MMS message provided through the second subscriber terminal.

When the subscriber of the first subscriber terminal requests the retransmission the MMS notification message through the SMS center 160 at step 24 and step 26, the service server 130 retransmits the MMS notification messages used for receiving the MMS message, which has not been received in the first subscriber terminal, or the MMS message, which has been provided through the second subscriber terminal, through the SMS center 160 at step 28 and step 30.

Further, when the MMS message is provided to the first subscriber terminal after the subscriber of the first subscriber terminal requests the MMS message through the first subscriber terminal at step 32, the service server 130 retransmits the MMS notification messages used for receiving the MMS message, which has not been received in the first subscriber terminal, or the MMS message, which has been provided through the second subscriber terminal, through the SMS center 160 at step 34 and step 36.

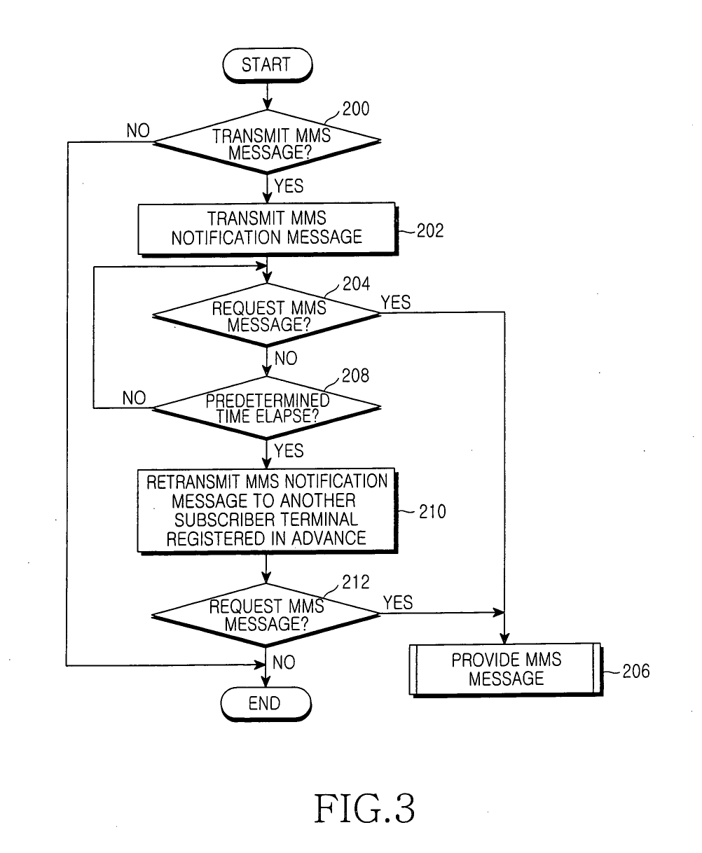

Hereinafter, the retransmission procedure of the MMS notification message according to the present invention, which has been briefly described in FIG. 2, will be described in detail with reference to the flow charts shown in FIGS. 3 to 5.

FIG. 3 is a flow chart illustrating the retransmission process of the MMS notification message when a subscriber terminal does not request the transmission of an MMS message in relation to the MMS notification message even after passage of a predetermined time after the transmission of the MMS notification message.

First, when a subscriber terminal, a service provider, etc, requests the service server 130 to transmit the MMS message at step 200, the service server 130 generates an MMS notification message including information used for receiving the corresponding MMS message, and transmits the generated MMS notification message to the corresponding subscriber terminal through the SMS center 160 at step 202. The service server 130 than checks whether a subscriber requests the MMS message through its own subscriber terminal before passage of a predetermined time after the transmission of the MMS notification message at step 204 and step 208. As a result of the checking, when the subscriber requests the MMS message before the predetermined period of time elapses, the service server 130 provides the corresponding subscriber terminal with the corresponding MMS message at step 206.

In contrast, when the subscriber does not request the MMS message in relation to the MMS notification message even after the predetermined period of time elapses, the service server 130 retransmits the MMS notification message to another subscriber terminal registered in advance through the SMS center 160 at step 210. Herein, the subscriber terminal receiving the retransmitted MMS notification message may change according to the request of a subscriber through a wireless network.

Then, after the MMS notification message has been retransmitted to said another subscriber terminal, when the subscriber requests the MMS message through said another subscriber terminal at step 212, the service server 130 provides said another subscriber terminal with the MMS message according to the request for the MMS message at step 206. Herein, the service server 130 stores information representing whether an MMS message has been transmitted to the subscriber terminal of the subscriber itself, information representing whether an MMS message has been transmitted to another subscriber terminal, and information for an MMS notification message retransmitted to another subscriber terminal. The above information may be retransmitted to the subscriber terminal of the subscriber itself by the request of the subscriber.

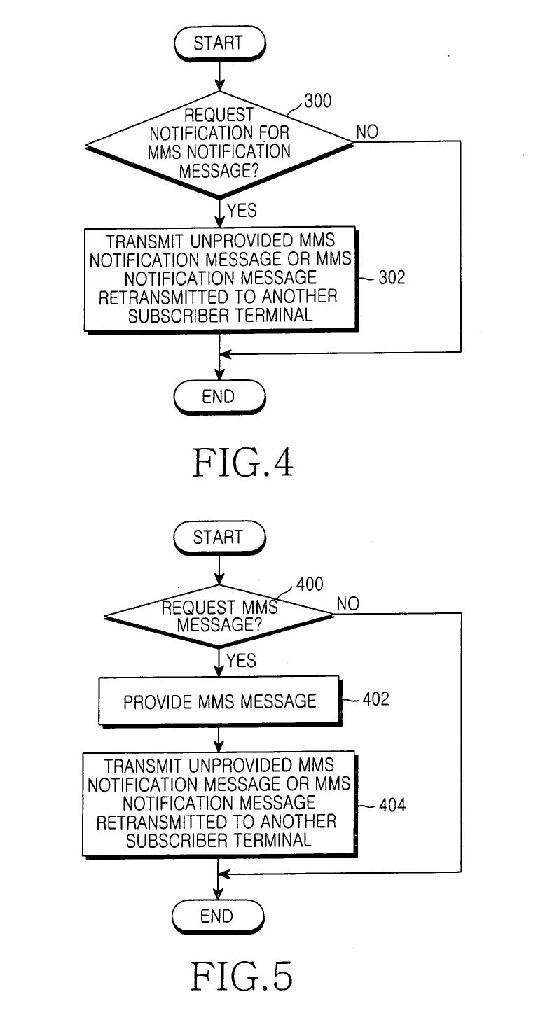

FIG. 4 is a flow chart illustrating a process for receiving an MMS notification message used for receiving an MMS message, which has not yet been provided, or an MMS notification message, which has been retransmitted to another subscriber terminal, by the request of a subscriber.

First, the service server 130 checks whether a subscriber requests a notification for the MMS notification message used for receiving the MMS message, which has not yet been transmitted to the subscriber terminal of the subscriber itself, or the MMS notification message retransmitted to another subscriber terminal at step 300. As a result of the checking, when the subscriber requests the notification for the MMS notification message through the subscriber terminal of the subscriber itself, the service server 130 generates the MMS notification message used for receiving the MMS message, which has not yet been transmitted to the subscriber terminal of the corresponding subscriber itself, or the MMS notification message retransmitted to said another subscriber terminal. Then, the service server 130 retransmits the generated MMS notification message to the corresponding subscriber terminal through the SMS center 160 at step 302.

FIG. 5 is a flow chart illustrating a process for automatically retransmitting an MMS notification message used for receiving an MMS message that has not yet been provided or an MMS notification message, which has been retransmitted to another subscriber terminal, whenever a subscriber terminal receives an MMS message.

First, the service server 130 checks whether a subscriber requests an MMS message through the subscriber terminal of the subscriber itself at step 400. Herein, the request for the MMS message represents a state in which the corresponding subscriber terminal normally operates. Then, the service server 130 provides the requested MMS message to the corresponding subscriber terminal at step 402. In addition, the service server 130 automatically generates the MMS notification message used for receiving the MMS message which has not yet been provided or the MMS notification message retransmitted to said another subscriber terminal, and retransmits the generated MMS notification message to the corresponding subscriber terminal through the SMS center 160 at step 404.

Meanwhile, in a second preferred embodiment of the present invention, a subscriber can request the retransmission of an MMS notification message, which has been transmitted to the subscriber terminal of the subscriber itself, through another terminal, and can receive the MMS notification message.

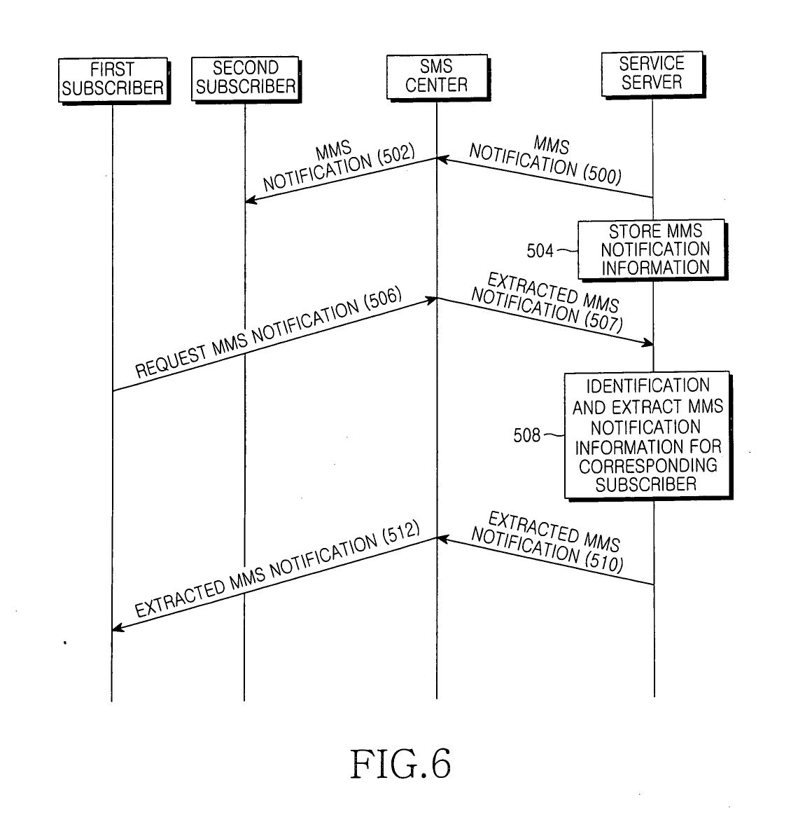

Hereinafter, the second preferred embodiment of the present invention will be described with reference to the flow diagram shown in FIG. 6.

First, when an MMS message to be provided to a subscriber (e.g., a second subscriber) is generated, the service server 130 notifies a second subscriber terminal of the MMS message through the SMS center 160 at steps 500 and 502.

After notifying the second subscriber of the MMS message, the service server 130 stores notification information for the MMS message, that is, MMS notification information. Herein, the MMS notification information includes information for the second subscriber, information representing whether the MMS message is received, etc at step 504.

When the second subscriber cannot receive the notification for the MMS message through the second subscriber terminal, the second subscriber may request the notification for the MMS message through a first subscriber terminal which can be another subscriber's terminal.

The second subscriber may request the notification for the MMS message through the first subscriber terminal by means of an SMS message, that is, an MMS notification request message. Herein, the MMS notification request message includes identification information for the second subscriber terminal, authentication information for authenticating the second subscriber terminal, identification information for the first subscriber terminal, etc. at steps 506 and 507.

The service server 130 performs an authentication for the first subscriber by means of the identification information and the authentication information for the first subscriber terminal included in the MMS notification request message. When the authentication is successful, the service server 130 extracts MMS notification information provided to the first subscriber terminal at step 508.

When the MMS notification information has been completely extracted, the service server 130 provides the second subscriber terminal with the extracted MMS notification information through the SMS center 160 at steps 510 and 512.

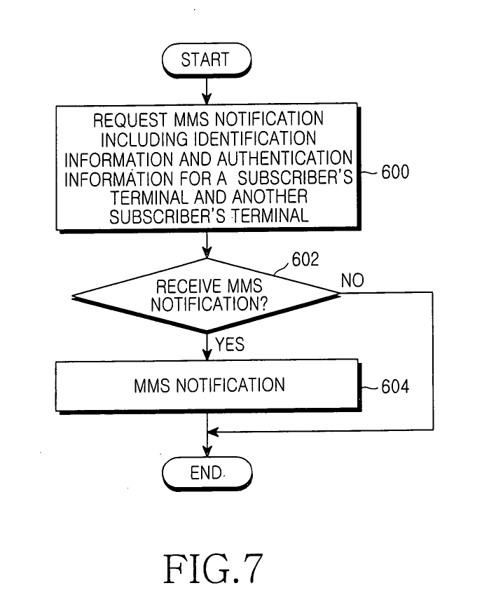

Hereinafter, an operation of the second subscriber terminal in the procedure shown in FIG. 6 will be described in detail with reference to FIG. 7.

First, the second subscriber terminal transmits an SMS message, which includes identification information for another subscriber terminal and authentication information for the subscriber of said another subscriber terminal, to the service server 130 through the SMS center 160 according to a user's at step S600. Herein, since the SMS message includes the phone number of the second subscriber terminal, the service server 130 receives the identification information for said another subscriber terminal, information for authenticating the owner of said another subscriber terminal, and identification information for the corresponding subscriber terminal.

When the service server 130 provides the second subscriber terminal with an MMS notification through the SMS center 160 according to the MMS notification request message and the second subscriber receives this MMS notification at step 602, the second subscriber terminal notifies the user of information in relation to the received MMS notification at step 604. Herein, the user can receive an MMS message according to the notified MMS notification, similarly to a typical case.

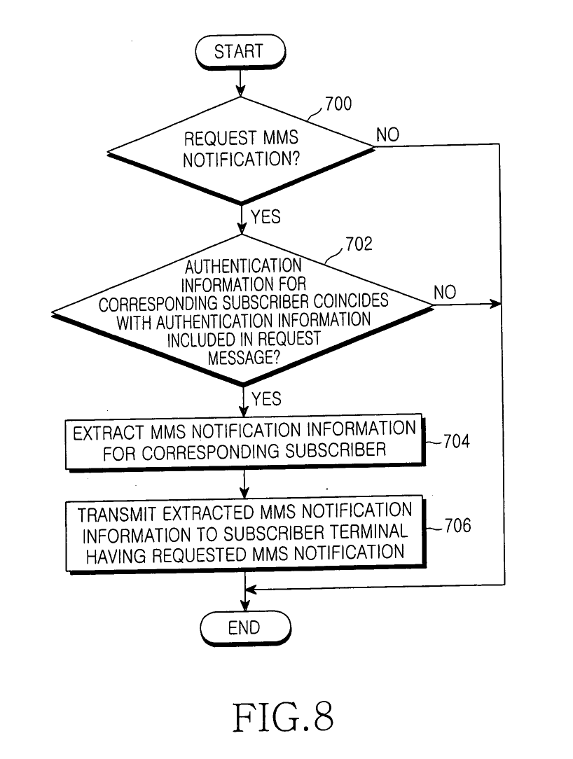

Hereinafter, an operation of the service server 130 in the procedure shown in FIG. 6 will be described in detail with reference to FIG. 8.

First, the service server 130 determines whether a subscriber terminal requests an MMS notification for another subscriber at step 700. As a result of the determination, when the subscriber terminal requests the MMS notification for said another subscriber, the service server 130 compares authentication information for authenticating the subscriber of said another subscriber terminal, which is provided in the request, with authentication information registered in advance, and determines whether the two authentication information coincide with each other at step 702.

As a result of the determination, when the two authentication information are in accord with each other, the service server 130 extracts MMS notification information for said another subscriber at step 704, and transmits the extracted MMS notification information to the subscriber terminal having requested the MMS notification at step 706.

As described above, in the present invention, an MMS notification message can be retransmitted to another subscriber terminal, so that a subscriber can receive an MMS message on the another subscriber terminal even though the first subscriber's terminal is in an abnormal state, is lost, or is not carried by the subscriber.

Further, in the present invention, after the first subscriber's terminal returns to a normal state, the first subscriber's terminal can receive an MMS message retransmitted to another subscriber's terminals, thereby satisfying various desires of a subscriber intended for holding an MMS message provided through other subscriber's terminals.

Although a preferred embodiment of the present invention has been described for illustrative purposes, those skilled in the art will appreciate that various modifications, additions and substitutions are possible, without departing from the scope and spirit of the invention as disclosed in the accompanying claims, including the full scope of equivalents thereof.

What is claimed is:

1. A method for transmitting a multimedia message service (MMS) notification message, the method comprising the steps of:
transmitting the MMS notification message including information used for receiving an MMS message to a receiving subscriber terminal; and
retransmitting the MMS notification message to another subscriber terminal designated in advance by a subscriber of the subscriber terminal when one of a transmission check information of the MMS notification message is not provided from the subscriber terminal and the MMS message is not requested by the subscriber terminal within a predetermined period of time.

2. The method in claim 1, further comprising the steps of:
storing information representing whether the MMS message corresponding to the MMS notification message is provided; and
retransmitting an MMS notification message for an unprovided MMS message based on the information representing whether the MMS message is provided, when an MMS notification is requested by the subscriber of the subscriber terminal.

3. The method in claim 1, further comprising the steps of:
storing information representing whether the MMS message corresponding to the MMS notification message is provided; and
providing the MMS message and retransmitting an MMS notification message for an MMS message, which has not been provided to the subscriber terminal, to the subscriber terminal, when the MMS message is requested by the subscriber of the subscriber terminal.

4. The method in claim 1, further comprising the steps of:
storing the MMS notification message retransmitted to said another subscriber terminal; and
transmitting the stored MMS notification message retransmitted to said another subscriber terminal to the subscriber terminal when a notification for the MMS notification message retransmitted to said another subscriber terminal is requested by the subscriber of the subscriber terminal.

5. The method in claim 1, further comprising the steps of:
storing the MMS notification message retransmitted to said another subscriber terminal; and
providing the MMS message and retransmitting the MMS notification message retransmitted to said another subscriber terminal to the subscriber terminal, when the MMS message is requested by the subscriber of the subscriber terminal.

6. A multimedia messaging service (MMS) system comprising:
subscriber terminals for requesting and receiving an MMS message through a wireless network by means of information used for receiving the MMS message included in an MMS notification message;
an Short Message Service (SMS) center for receiving the MMS notification message and providing the MMS notification message to a corresponding subscriber terminal; and
a service server for generating the MMS notification message for the MMS message and transmitting the MMS notification message to the corresponding subscriber terminal through the SMS center when the MMS message is requested by the corresponding subscriber terminal of the subscriber terminals, and retransmitting the MMS notification message to another subscriber terminal designated in advance if at least one of a transmission check information of the MMS notification message is not provided and a request for the MMS message within a predetermined period of time is not requested by the corresponding subscriber terminal.

7. The MMS system in claim 6, wherein the service server stores information representing whether the MMS message corresponding to the MMS notification message is provided, and
retransmits an MMS notification message for an unprovided MMS message to the corresponding subscriber terminal based on the information representing whether the MMS message is provided, when an MMS notification is requested by the subscriber of the subscriber terminal.

8. The MMS system in claim 6, wherein the service server stores information representing whether the MMS message corresponding to the MMS notification message is provided, and
provides the MMS message and retransmits an MMS notification message for an MMS message, which has not been provided to the subscriber terminal, to the subscriber terminal, when the MMS message is requested by the subscriber of the subscriber terminal.

9. The MMS system in claim 6, wherein the service server stores the MMS notification message retransmitted to said another subscriber terminal, and
transmits the stored MMS notification message retransmitted to said another subscriber terminal to the subscriber terminal when a notification for the MMS notification message retransmitted to said another subscriber terminal is requested by a subscriber of the subscriber terminal.

10. The MMS system in claim 6, wherein the service server stores the MMS notification message retransmitted to said another subscriber terminal, and
provides the MMS message and retransmits the MMS notification message retransmitted to said another subscriber terminal to the subscriber terminal, when the MMS message is requested by a subscriber of the subscriber terminal.

11. A method for transmitting a multimedia message service (MMS) notification message, the method comprising the steps of:
providing an MMS service server with identification information for a subscriber terminal and identification information for another subscriber terminal in order to request an MMS notification message transmitted to said another subscriber terminal; and
extracting by the MMS service server an already stored MMS notification message for said another subscriber terminal and transmitting the extracted the MMS notification message to the subscriber terminal having requested an MMS notification, according to the request.

12. The method in claim 11, wherein the subscriber terminal provides the MMS service server with authentication information for authenticating a user of said another subscriber terminal when requesting the MMS notification, and the MMS service server determines whether the authentication information coincides with authentication information registered in advance and performs the MMS notification only when the two authentication information coincide with each other.

13. A multimedia message service (MMS) system comprising:
subscriber terminals for requesting an MMS notification message transmitted to another subscriber terminal;
an SMS center for receiving a request message for an MMS notification message from the subscriber terminal and transmitting the request message; and
a service server for, when a subscriber terminal of the subscriber terminals requests the MMS notification message transmitted to said another subscriber terminal, reading an already stored MMS notification message for said another subscriber terminal and transmitting the read MMS notification message to the subscriber terminal having requested the MMS notification message,
wherein the SMS center transmits the request message for the MMS notification message of the subscriber terminal to the service server, and transmits the MMS notification message of the service server to the subscriber terminal.

14. The MMS system in claim 13, wherein the subscriber terminal provides the MMS service server with authentication information for authenticating a user of said another subscriber terminal when requesting the MMS notification, and
the MMS service server checks whether the authentication information coincides with authentication information registered in advance and performs the MMS notification only when the two authentication information coincide with each other.
